(19) United States
(12) Patent Application Publication
(10) Pub. No.: US 2021/0367785 A1
(43) Pub. Date: Nov. 25, 2021

(54) METHOD AND DEVICE FOR SHARING CONTENT

(71) Applicant: BEIJING DAJIA INTERNET INFORMATION TECHNOLOGY CO., LTD, Beijing (CN)

(72) Inventors: Jiejie Chu, Beijing (CN); Chao Chen, Beijing (CN)

(21) Appl. No.: 17/137,872

(22) Filed: Dec. 30, 2020

(30) Foreign Application Priority Data
May 20, 2020 (CN) 202010431852.1

(51) Int. Cl. H04L 9/32; H04L 12/58; H04L 9/08

(52) U.S. Cl. CPC H04L 9/3213; H04L 51/046; H04L 51/10; G06F 16/438; H04L 9/0863; H04L 2209/60; H04L 51/22

(57) ABSTRACT

Embodiments of the disclosure provide a method for sharing content and a related terminal device. The method is applicable by an electronic device. The electronic device obtains a target emoji sequence based on an instruction related to target content. The target emoji sequence corresponds to the target content. In addition, the electronic device obtains a sharing token based on the target emoji sequence. Furthermore, the electronic device shares the target content based on the sharing token.

### CROSS REFERENCE TO RELATED APPLICATIONS

This application is based on and claims priority to Chinese Patent Application No. 202010431852.1, filed on May 20, 2020, in the China National Intellectual Property Administration, the disclosure of which is herein incorporated by reference in their entireties.

### FIELD

The disclosure relates to a field of communication technologies, and more particularly to a method and a device for sharing content.

### BACKGROUND

At present, a method for sharing content based on a sharing password has been widely used as a common method for sharing content.

For example, the terminal device can generate and display a sharing token to a content sharing user based on target content to be shared by the content sharing user. The sharing token may be copied through the content sharing user to one or more other terminal devices through a social application. After receiving the sharing token, users of the one or more other terminal devices can access the target content based on the sharing token.

### SUMMARY

Embodiments of the disclosure provide a method for sharing content, applicable to an electronic device. The method includes: obtaining a target emoji sequence based on an instruction related to target content, in which the target emoji sequence corresponds to the target content; obtaining a sharing token based on the target emoji sequence; and sharing the target content based on the sharing token.

Embodiments of the disclosure provide a method for sharing content, being applicable to an electronic device. The method includes obtaining an instruction including a target emoji sequence; and obtaining target content corresponding to the target emoji sequence.

Embodiments of the disclosure provide an electronic device. The electronic device includes a processor, and a memory configured to store instructions executable by the processor. The processor is configured to execute the instructions to implement operations of: obtaining a target emoji sequence based on an instruction related to target content, in which the target emoji sequence corresponds to the target content; obtaining a sharing token based on the target emoji sequence; and sharing the target content based on the sharing token.

It should be understood, the above general description and the following detailed description are only exemplary and explanatory, and do not limit the disclosure.

### BRIEF DESCRIPTION OF THE DRAWINGS

The drawings, incorporated into the specification as a part of the specification, illustrate embodiments of the disclosure and are used to explain the principle of the disclosure together with the specification, which are not construed to be an improper limitation of the disclosure.

FIG. 1 is a flowchart illustrating a method for sharing content according to embodiments of the disclosure.

FIG. 2 is a flowchart illustrating a method for sharing content according to embodiments of the disclosure.

FIG. 3 is a schematic diagram illustrating a transmission network according to embodiments of the disclosure.

FIG. 4 is a flowchart illustrating a method for sharing content according to embodiments of the disclosure.

FIG. 5 is a schematic diagram illustrating a display interface of a terminal device according to embodiments of the disclosure.

FIG. 6 is a schematic diagram illustrating a display interface of a terminal device according to embodiments of the disclosure.

FIG. 7 is a schematic diagram illustrating a display interface of a terminal device according to embodiments of the disclosure.

FIG. 8 is a flowchart illustrating a method for sharing content according to embodiments of the disclosure.

FIG. 9 is a flowchart illustrating a method for obtaining a target emoji sequence according to embodiments of the disclosure.

FIG. 10 is a schematic diagram illustrating a correspondence between emojis and digits according to embodiments of the disclosure.

FIG. 11 is a flowchart illustrating a method for determining target content according to embodiments of the disclosure.

FIG. 12 is a schematic diagram illustrating a display interface of a terminal device according to embodiments of the disclosure.

FIG. 13 is a flowchart illustrating a method for sharing content according to embodiments of the disclosure.

FIG. 14 is a flowchart illustrating a method for sharing content according to embodiments of the disclosure.

FIG. 15 is a flowchart illustrating a method for sharing content according to embodiments of the disclosure.

FIG. 16 is a flowchart illustrating a method for sharing content according to embodiments of the disclosure.

FIG. 17 is a schematic diagram illustrating a terminal device according to embodiments of the disclosure.

FIG. 18 is a schematic diagram illustrating a terminal device according to embodiments of the disclosure.

FIG. 19 is a schematic diagram illustrating a terminal device according to embodiments of the disclosure.

FIG. 20 is a schematic diagram illustrating a server according to embodiments of the disclosure.

FIG. 21 is a schematic diagram illustrating a server according to embodiments of the disclosure.

FIG. 22 is a schematic diagram illustrating a server according to embodiments of the disclosure.

### DETAILED DESCRIPTION

In order to enable the skilled person in the art to understand technical solutions of the disclosure, the technical solution according to embodiments of the disclosure will be described clearly and completely with reference to the accompanying drawings.

It should be noted that terms “first” and “second” in the specification, appended claims and the above-mentioned drawings are used to distinguish similar objects, and not necessarily used to describe a specific sequence or sequence. It should be understood, features defined by these terms can be interchanged in appropriate circumstances so that embodiments of the disclosure described herein can be implemented in an order other than those illustrated or described herein. Implementations described in following embodiments do not represent all implementations consistent with the disclosure. Instead, the implementations are examples of devices and methods consistent with some aspects of the disclosure as detailed in the appended claims.

In addition, in the description of the disclosure, unless otherwise specified, a symbol “/” means “or”. For example, A/B means A or B. The phrase “and/or” used herein is only to describe relationships of related objects, including three relationships. For example, A and/or B means only A, only B, and both A and B. In addition, in the description of the disclosure, “a plurality of” means two or more.

In an existing method for sharing content based on a sharing token, the sharing token is consisted of words, letters, numbers and other symbols. The sharing token includes a token code for indicating the target content. In addition to the token code, the sharing token can also include other content for users to read.

For example, “Choose a number to hit a jackpot, ##X-acOREZjKe6nq2v_V## Copy this description and start an application” is an example of an existing sharing token. The sharing token includes a token code (i.e, “##X-acOREZjKe6nq2v_V##”) indicating the target content to be shared and other content (i.e. “Choose a number to hit a jackpot” and “Copy this description and start an application”) for the users to read. The token code includes flags “##” for indicating a position of the token and content of the token code “X-acOREZjKe6nq2v_V” corresponding to the target content.

The existing method may have following technical defects. The token code in the sharing token is generally a combination of letters and numbers. This combination causes that the token code in the sharing token is understood as “unreadable/unintelligible codes” from the user's point of view, which affects the user experience.

Therefore, how to make the sharing token displayed to users comprehensible and interesting, and how to avoid “unreadable codes” in the sharing password are problems to be solved.

Embodiments of the disclosure provide a method and a device for sharing content, related terminal device, related servers and related storage media to solve the above technical problem.

Technical terms used in the disclosure may be described below.

The term “sharing token” includes (or is consisted of) a combination of words, letters, numbers and other symbols. This combination includes a token code for indicating target content. In addition to the token code, the sharing token also includes other content that enables a user to read.

The target content and usage of the sharing token may be described below. The sharing token includes content enabling users to read, such as a description about features of the target content to be shared and a description about the usage of the sharing token.

For identifying the token code in the sharing token, the token code generally includes a flag and content of the token code. The flag is configured to identify a position of the token code in the sharing token. For example, the flag may include a starting flag and an ending flag. The content of the token code has a correspondence with respect to the target content to be shared and is configured to indicate the target content.

For example, flags “##” are located before and after the content of the token code respectively, where “##” is the starting flag and the ending flag of the token code respectively.

In use, when a content sharing user desires to share the target content of an application to other users, the terminal device may display the sharing token corresponding to the target content to the content sharing user. The sharing token is copied through the content sharing user to a dialog interface of a social application having social functions to send the sharing token to terminal devices of other users (in some implementations, the sharing token may be shared through social functions of the application to the terminal devices of other users). After receiving the sharing token, the sharing token can be copied through the other users to a corresponding application. The terminal devices can find and access the target content in the corresponding application based on the token code in the sharing token. Therefore, a process of content sharing is realized.

With the above method, addresses of short videos, live broadcast rooms, Hyml 5 interface and other content may be shared to other users.

Embodiments of the disclosure provide a method for sharing content, which will be described in detail below.

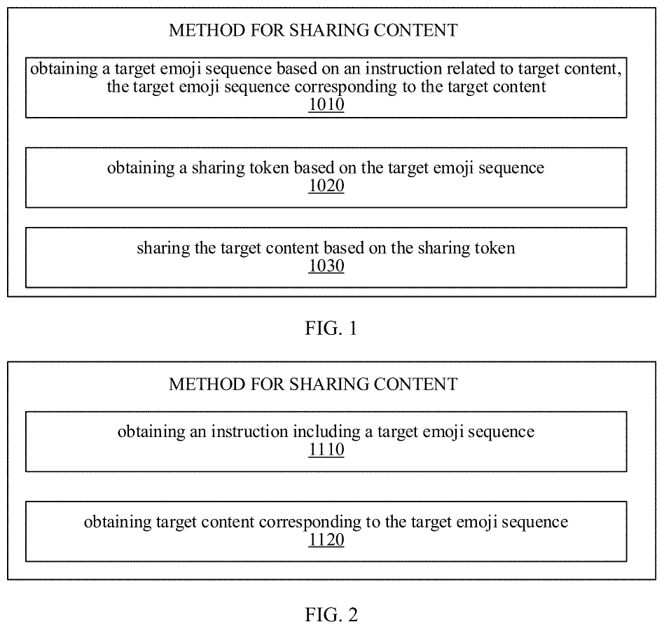

FIG. 1 is a flowchart illustrating a method for sharing content according to embodiments of the disclosure. In some embodiments, the method may be executed by an electronic device, which may be a terminal device or a server. As illustrated in FIG. 1, the method includes the following.

At 1010, the electronic device may obtain a target emoji sequence based on an instruction related to target content. The target emoji sequence corresponds to the target content.

At 1020, the electronic device may obtain a sharing token based on the target emoji sequence.

At 1030, the electronic device may share the target content based on the sharing token.

In some embodiments, when the electronic device is a terminal device, the instruction is a sharing operation. When the electronic device is a server, the instruction is an emoji generation instruction.

FIG. 2 is a flowchart illustrating a method for sharing content according to embodiments of the disclosure. In some embodiments, the method may be executed by an electronic device, which may be a terminal device or a server. As illustrated in FIG. 2, the method includes the following.

At 1110, the electronic device may obtain an instruction including a target emoji sequence.

At 1120, the electronic device may obtain target content corresponding to the target emoji sequence.

In some embodiments, when the electronic device is a terminal device, the instruction is a shaking token. When the electronic device is a server, the instruction is a content obtaining instruction.

Below, an application scenario of the technical solution according to embodiments of the disclosure may be described.

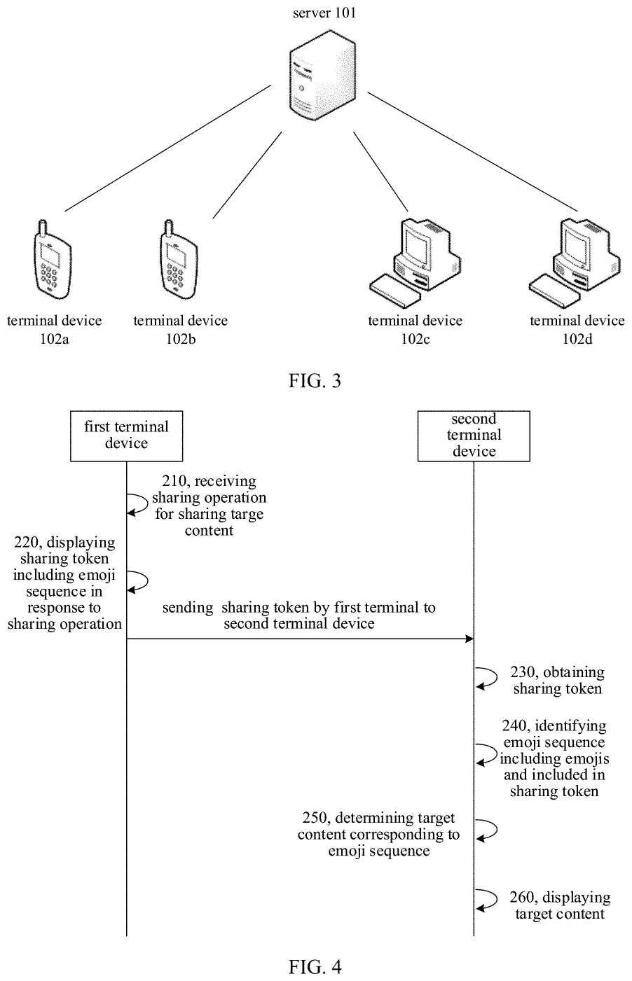

FIG. 3 illustrates a diagram of an implementation environment related to embodiments of the disclosure. As illustrated in FIG. 3, the implementation environment may include a server 101 and multiple terminal devices (such as a terminal device 102a, a terminal device 102b, a terminal device 102c, and a terminal device 102d). The multiple terminal devices may be configured to communicate with the server 101 through a wired network or a wireless network.

For example, the terminal device in embodiments of the disclosure may have instant messaging applications installed thereon and use the instant messaging applications for communication, such as a mobile phone, a tablet computer, a desktop computer, a laptop, a handheld computer, a notebook computer, an ultra-mobile personal computer (UMPC), a netbook, a cellular phone, a personal digital assistance (PDA), an augmented reality (AR)\virtual reality (VR) device, which is not limited in the disclosure.

The server 101 may be used by a content issuing platform to issue content. For example, the server 101 may be configured to send content, such as short videos and data of live rooms, to multiple terminal devices in a wired or wireless manner. After the content sharing user views the target content issued by the server 101 through a first terminal device of the multiple terminal devices (for example, the first terminal device may be any one of the multiple terminal devices illustrated in FIG. 3), the first terminal device may be configured to display the sharing token including a target emoji sequence to the content sharing user based on the method according to embodiments of the disclosure, to realize the process of content sharing.

In addition, the server 101 may be configured to execute the methods according to embodiments of the disclosure. For example, after receiving a sharing operation for sharing the target content form a user, the first terminal device may be configured to generate a target emoji sequence corresponding to the target content by utilizing the software and hardware resources of the first terminal device and generate the sharing token including the target emoji sequence to realize the content sharing. In addition, the first terminal device may be configured to send an emoji generation instruction to the server 101. The server 101 may be configured to generate the target emoji sequence based on the emoji generation instruction and send the target emoji sequence to the first terminal device. The first terminal device may be configured to generate the sharing token including the target emoji sequence. Furthermore, after receiving the emoji generation instruction, the server 101 may be configured to generate the sharing token including the target emoji sequence and send the sharing token to the first terminal device.

In addition, after a second terminal device of the multiple terminal devices (for example, the second terminal device may be any one of the multiple terminal devices except the first terminal device illustrated in FIG. 3) receives the sharing token from the first terminal device, the second terminal device may be configured to parse the sharing token by utilizing the software and hardware resources of the second terminal device to determine the target content corresponding to the target emoji sequence included in the sharing token and send the target content to the user. In addition, the second terminal device may be configured to send the target emoji sequence included in the sharing token to the server 101. After receiving the target emoji sequence, the server 101 may be configured to determine the target content corresponding to the target emoji sequence and send the target content to the second terminal device. Furthermore, the second terminal device may be configured to send the sharing token to the server 101. After receiving the sharing token, the server 101 may be configured to parse the sharing token to determine the target content corresponding to the target emoji sequence and send the target content to the second terminal device.

In some implementations, the server 101 may be configured to transmit the sharing token between terminal devices. For example, the first terminal device may send the sharing token to the server 101 and the server 101 may be configured to forward the sharing token to the second terminal device to realize the transmission of the sharing token. In addition, in cases that the first terminal device sends the sharing token to the second terminal device through other social applications other than the content issuing platform, the transmission of the sharing token between the terminal devices can be performed by a server other than the server 101, which is not limited in the disclosure.

Technical principles of the technical solutions according to embodiments of the disclosure may be described below.

In the disclosure, a problem that the user experience is degraded by a part of the token code in an existing sharing token which is unreadable by the user is considered.

In addition, in the existing sharing token, the token code having the correspondence with the target content is a series of letters and numbers. However, the users generally do not use a series of letters or numbers to chat with others. As a result, the sharing code may be easily identified in transmission. For example, after a hacker intercepts the chat history between users, the sharing token may be filtered out from the chat history through some simple algorithms, to obtain relevant personal information of the users. Therefore, transmission security of the existing sharing token is low.

In view of the above technical problems, in the disclosure, a target emoji sequence including multiple emojis is configured to indicate the target content. That is, a correspondence is established between the target emoji sequence and the target content. The sharing token includes the target emoji sequence. Based on the correspondence between the target emoji sequence and the target content in the sharing token, the garbled codes that are unreadable are not included in the sharing token. Emojis are commonly used in social dialogs of users, and the sharing token generated according to embodiments of the disclosure is difficult to be identified.

In some embodiments, the above-mentioned method may realize the content sharing based on the sharing token.

In some embodiments, the above-mentioned method may improve the user experience.

In some embodiments, the above-mentioned method may improve security of the sharing token during the transmission.

Based on the foregoing technical principles, the method for sharing content according to embodiments of the disclosure will be described below in conjunction with embodiments. As illustrated in FIG. 4, the method may include the following.

At 210, the first terminal device may receive a sharing operation for sharing target content.

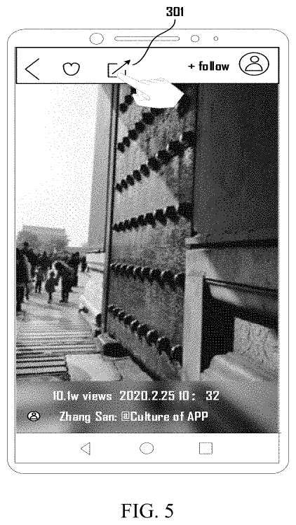

In detail, the sharing operation refers to an operation performed by a user to share a video, an audio, a text, or other content (that is, target content). For example, when a user watches a short video through an application A of short videos and desires to share the short video with a friend, the user may click a sharing control displayed on an interface of application A to share the short video. The first terminal device may be configured to receive the sharing operation from the user. As illustrated FIG. 5, the user can click the sharing control 301 displayed on the interface of the terminal device to implement the above operations.

At 220, in response to the sharing operation, the first terminal device may display the sharing token including a target emoji sequence to the user.

The target emoji sequence includes multiple emojis. The target emoji sequence has a correspondence with the target content. For example, the target emoji sequence corresponds to an access address of the target content. The access address of the target content can be found based on the target emoji sequence to access the target content.

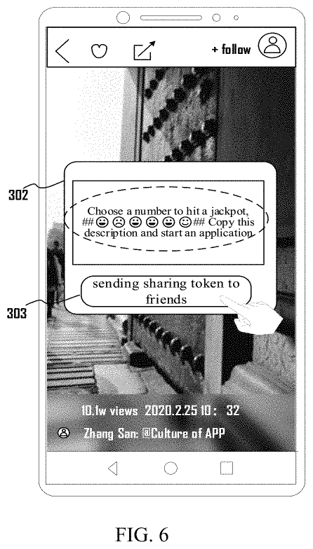

For example, when the content sharing user clicks the sharing control on the interface illustrated in FIG. 5, the first terminal device may be configured to display an interface illustrated as FIG. 6, in response to the sharing operation of clicking the sharing control. In detail, the sharing token that includes multiple emojis and is enclosed by a dashed circle is displayed on the dialog box 302 in FIG. 6. In addition, the dialog box 302 also includes a control 303. After the content sharing user clicks the control 303, the first terminal device may be configured to copy the displayed sharing token and start a social application to send the sharing token to other users.

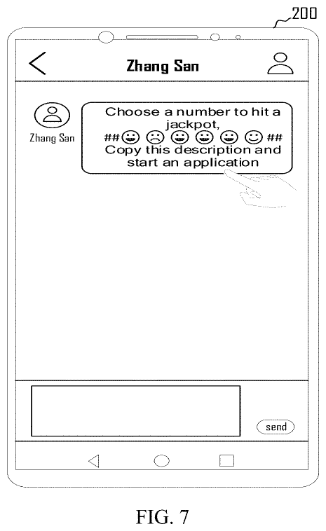

After the content sharing user sends the sharing token to the other users, a dialog interface illustrated as FIG. 7 is displayed on the second terminal device of other users. Further, the sharing token displayed on the dialog interface illustrated as FIG. 7 may be copied through the user. After detecting an operation for copying the sharing token through the user and an operation for starting a corresponding application of short videos, the second terminal device may be configured to access the target content in the corresponding application of short videos based on the target emoji sequence included in the sharing token. Therefore, the method may also include the following.

At 230, the second terminal device may obtain the sharing token.

At 240, the second terminal device may identify a target emoji sequence included in the sharing token. The target emoji sequence includes multiple emojis.

In detail, as described above, the second terminal device can be configured to identify the starting flag and the ending flag, such as “##”, in the sharing token to obtain the target emoji sequence between the starting flag and the ending flag.

In implementations, the second terminal device may be configured to identify the target emoji sequence including the multiple emojis from the sharing token by utilizing its own software and hardware resources. As another implementation, the second terminal device may be configured to send the shared password to the server, and the server may be configured to identify the target emoticon sequence including multiple emojis and included in the sharing token.

At 250, the second terminal may determine the target content having the correspondence with the target emoji sequence based on the target emoji sequence.

For example, through a database including preset correspondences between target emoji sequences and pieces of content to be selected of an application of short videos, the target content corresponding to the target emoji sequence can be determined. For example, the database may be configured to store correspondences between multiple target emoji sequences and multiple identifications such as access addresses of the pieces of content.

In some implementations, the second terminal device may be configured to send the target emoji sequence to the server. The server may be configured to determine the target content based on the target emoji sequence and send the target content to the second terminal device.

At 260, the second terminal device may display the target content.

With the technical solution according to the disclosure, after receiving the sharing operation for sharing the target content from the user, the sharing token including the target emoji sequence corresponding to the target content is displayed to the user. Therefore, the target content can be determined based on the target emoji sequence included in the sharing token, without including the token code having the content consisted of numbers and letters into the sharing token.

In some embodiments, the above-mentioned method may solve a problem that the user experience is poor since the sharing token includes too many unreadable symbols.

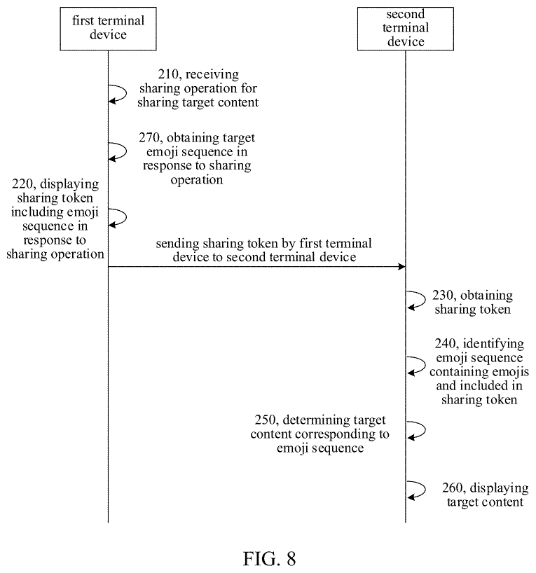

In some implementations, as illustrated in FIG. 8, in order to obtain the sharing token, before the 220 of displaying by first terminal device the sharing token including the target emoji sequence to the user in response to the sharing operation, the method may further include the following.

At 270, the first terminal device may obtain the target emoji sequence in response to the sharing operation.

In an existing relational database, a decimal or hexadecimal number may be used as an identity document (ID) of storage content. For example, in mySQL relational database, an integer of long type may be used as the ID of the storage content. Based on the above, in order to facilitate the device (for example, the server or the terminal device) to store the correspondence between the emoji sequences and the contents to be shared, in the disclosure, the target emoji sequence may be generated based on the identification value of the target content in the database. Therefore, based on the target emoji sequence, the target content may be accessed by finding the corresponding identification value.

For example, a unique sharing ID can be generated for each content to be shared. This unique ID can be an integer of long type. Therefore, the ID ranges from −2147483648 to 2147483647 (i.e., −2³² to (2³²−1), which may not be exhausted. The sharing ID corresponding to the target content and the access address of the target content are stored in the mySQL database. Based on the sharing ID corresponding to the target content, the sharing ID is converted into the target emoji sequence. In this way, the correspondence between the target emoji sequence and the target content can be established.

In some embodiments, the above-mentioned method may solve a problem that a space of the database is largely occupied and it is difficult to retrieve the target emoji sequence by directly storing the target emoji sequence.

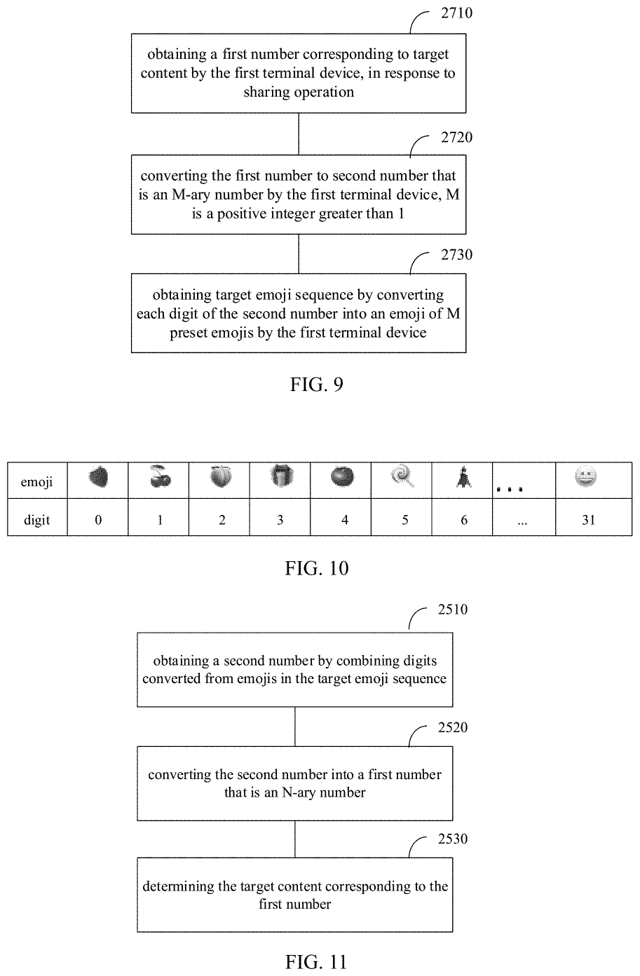

Based on the above, in the disclosure, as illustrated in FIG. 9, the 270 of obtaining the target emoji sequence may include the following.

At 2710, the first terminal device may obtain a first number corresponding to the target content in response to the sharing operation.

The first number may be the identification ID for identifying the target content in an existing database. For example, the existing database A includes all access addresses of the content to be shared on the content issuing platform stored therein, and each access address of the content to be shared corresponds to a unique identification ID in the database A. The unique identification ID can be used as the first number, and the target emoji sequence can be generated as follows.

In some embodiments, the first number may also be a sharing ID generated through a preset method by the first terminal device after receiving the sharing operation for sharing the target content from the user. The first terminal device may be configured to send the sharing ID to the server to establish the correspondence between the sharing ID and the target content.

The 2710 of obtaining the first number may include: in response to the sharing operation, generating, by the first terminal, the first number using an identity document (ID) generator and storing the correspondence between the first number and the target content.

Storing the correspondence between the first number and the target content may refer to storing the correspondence between the first number and the target content in a preset database of the first terminal device and periodically updating the correspondences between values and content in the preset database by the first terminal device to the server. In addition, storing the correspondence between the first number and the target content may further refer to sending by the first terminal device the first number and an identification (such as an address) of the target content to the server and storing by the server the correspondence between the first number and the target content to the preset database.

Therefore, storing the correspondence between the first number and the target content may include: storing the correspondence between the first number and the target content into a preset database. In the database, the access address of the target content is the storage content and the first number is the storage ID of the storage content.

In some implementations, the first number may be a long-type integer.

At 2720, the first terminal device may convert the first number into an M-ary number to obtain a second number, where M is a positive integer greater than 1.

For example, the first number is 107117730 and M is 32. The first number is converted into a 32-ary number, i.e. [3, 6, 4, 31, 5, 2], to obtain the second number.

At 2730, the first terminal device may convert each M-ary digit of the second number into an emoji selected from M preset emojis based on a one-to-one correspondence between the M preset emojis and M-ary digits from 0 to (M−1), to obtain the target emoji sequence.

In detail, M emojis are preset. The preset M emojis are coded, such that each of the preset M emojis respectively corresponds to one of the M-ary digits, i.e., 0 to (M−1).

In connection with the above example, M may be 32, and thus 32 emojis can be selected as the preset emojis. For example, FIG. 10 illustrates the correspondence between preset emojis and 32-ary digits (i.e., 0 to 31).

Based on the correspondence as illustrated in FIG. 10, the target emoji sequence can be obtained based on the second number [3, 6, 4, 31, 5, 2]. As illustrated in FIG. 10, the digit “3” corresponds to an emoji “Gift”, the digit “6” corresponds to an emoji “tower”, the digit “4” corresponds to an emoji “apple”, the digit “31” corresponds to an emoji “smiley”, and the digit “5” corresponds to an emoji “lollipop”, and the digit “2” corresponds to an emoji “Peach”. Therefore, the target emoji sequence includes “Gift”, “Tower”, “Apple”, “Smiley”, “Lollipop”, and “Peach”.

Based on the same principle, as illustrated in FIG. 11, the 250 of determining by the second terminal device the target content corresponding to the target emoji sequence based on the target emoji sequence may include the following.

At 2510, the second terminal device may convert each emoji included in the target emoji sequence into a digit based on the one-to-one correspondence between the M preset emojis and M-ary digits from 0 to (M−1), and combines the digits to obtain the second number that is an M-ary number, where M is a positive integer greater than 1.

At 2520, the second terminal device may convert the second number into the first number that is of an N-ary number, where N is an integer greater than 1 and N is different from M.

At 2530, the second terminal device may determine the target content corresponding to the first number based on the first number.

In detail, 2510-2530 can be inverse to the above-mentioned 2710-2730. For the implementation process of 2510-2530, the corresponding descriptions of 2710-2730 may be referred to, which are not repeated herein.

In some implementations, in order to facilitate the device to identify the target emoji sequence in the sharing token, flags may be including at the beginning and the ending of the target emoji sequence in the sharing token. For example, as illustrated in FIGS. 6 and 7, in the sharing token, flags “##” may be set at both the beginning and the ending of the emoji sequence.

In some implementations, in cases of using special symbols, such as # and *, as flags, there are less special symbols that are not commonly used (in the existing keyboard, only the symbols “# ¥%&*” corresponding to numbers 2-8 can be used as the flags). By considering the number special symbols is less, after the sharing token is sent to the second terminal device, the sharing token may be filtered out from chat history between users through simple algorithms based on the flags if someone intercepts the chat history, to obtain relevant personal information of the user. In addition, using special symbols, such as # and *, that are not commonly used as flags may degrade the user experience.

Therefore, in the disclosure, sharing token may include a target emoji before the target emoji sequence, a target emoji after the target emoji sequence, or both target emojis before and after the target emoji sequence.

The target emoji may be configured to indicate a starting position of the target emoji sequence in the sharing token, an ending position of the target emoji sequence in the sharing token, or both the starting position and the ending position.

In detail, the target emoji may include: a first target emoji arranged before the target emoji sequence, a second target emoji arranged after the target emoji sequence, or both the first target emoji and the second target emoji.

The first target emoji may be configured to indicate the starting position of the target emoji sequence in the sharing token, and/or the second target emoji may be configured to indicate the ending position of the target emoji sequence in the sharing token.

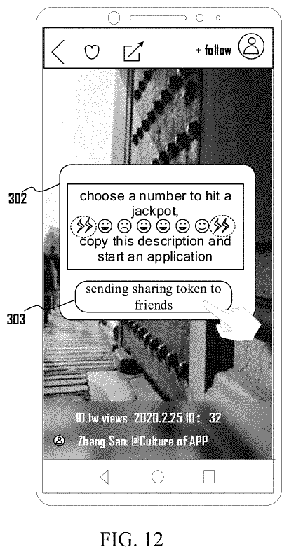

For example, in the sharing token displayed on the first terminal device to be user in FIG. 12, two “lightnings” (enclosed by dashed circles in FIG. 12) are arranged respectively before and after the target emoji sequence. The position of the emoji sequence in the sharing token can be determined based on the target emojis (i.e., the two “lightnings”).

In some embodiments, the above-mentioned method may solve the problem that the user experience is degraded since the sharing token contains unreadable symbols by the user.

In some embodiments, the above-mentioned method may reduce the possibility of identifying the sharing token and improve the security of transmitting the sharing token.

The 240 of identifying by the second terminal device the target emoji sequence including multiple emojis and included in the sharing token may include the following.

At 2410, the second terminal device may identify the target emoji included in the sharing token.

In some implementations, the 2410 of identifying the target emoji may include: identifying, by the second terminal device, the first target emoji, the second target emoji, or both the first target emoji and the second target emoji included in the sharing token. The first target emoji may be configured to indicate the starting position of the target emoji sequence in the sharing token, and/or the second target emoji is used to indicate the ending position of the target emoji sequence in the sharing token.

In some implementations, based on the sharing token including the first target emoji, the method may further include the following.

At 2420a, the second terminal device may read the preset number of emojis before the first target emoji in the sharing token to obtain the target emoji sequence.

For example, after identifying by the second terminal device that the first target emoji is included in the sharing token, the second terminal device reads A emojis before the first target emoji, and composes the A emojis into the target emoji sequence, where A can be a non-zero integer set in advance.

In some implementations, based on the sharing token including the second target emoji, the method may further include the following.

At 2420b, the second terminal device may read the preset number of emojis after the second target emoji in the sharing token to obtain the target emoji sequence.

For example, after identifying by the second terminal device that the second target emoji is included in the sharing token, the second terminal device may be configured to read A emojis after the second target emoji and compose A emojis into the target emoji sequence, where A can be a non-zero integer set in advance.

In some implementations, based on the sharing token including the first target emoji and the second target emoji, the method may further include the following.

At 2420c, the second terminal device may read multiple emojis between the first target emoji and the second target emoji in the shared password to obtain the target emoji sequence.

For example, after identifying the sharing token illustrated in FIG. 12 by the second terminal device, the second terminal device identifies two “lightnings” are included in the sharing token and further identify that two sets of “lightnings” are included. The second terminal device may be configured to read the emojis between the two sets of “lightnings” to obtain the target emoji sequence.

In some embodiments, a non-emoji symbol may be inserted between at least two adjacent emojis of the target emoji sequence of the sharing token.

In some embodiments, the above-mentioned method may improve the security of the sharing token and prevent the shared password from being identified and targeted.

The non-emoji symbol includes symbols composed of one or more of words, letters, and numbers.

For example, in the target emoji sequence of the sharing token, Chinese characters can be inserted between two adjacent emojis to improve the security of the sharing token.

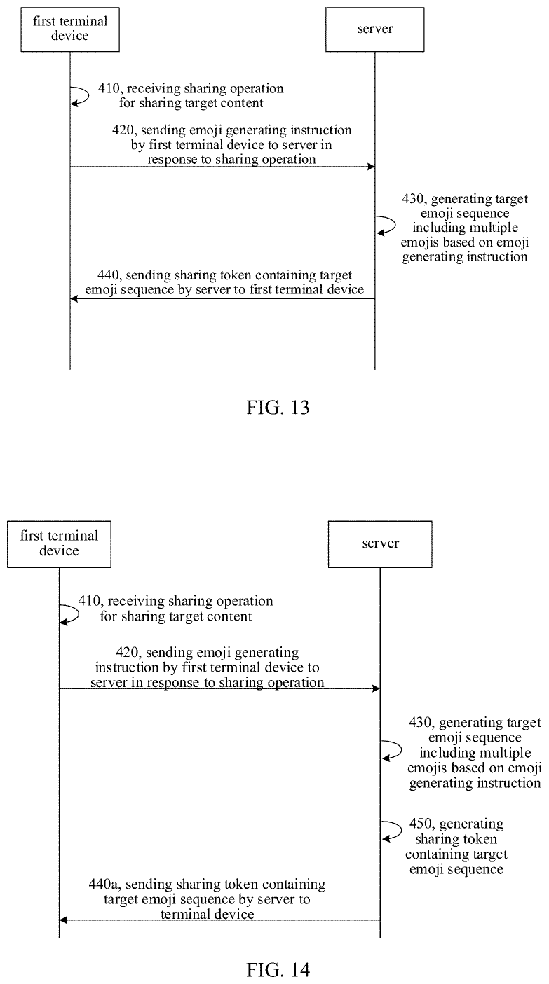

In a possible implementation, the software and hardware resources of the server can be used to implement generating the target emoji sequence and generating the sharing token in the disclosure. As illustrated in FIG. 13, the disclosure may further include the following.

At 410, the first terminal device may receive a sharing operation for sharing target content.

The implementation process of 410 may refer to the relevant descriptions of the 210.

At 420, the first terminal device may send an emoji generation instruction to the server in response to the sharing operation. The server may receive the emoji generation instruction from the terminal device.

The emoji generation instruction carries identification information of the target content. The emoji generation instruction may be configured to instruct to generate the target emoji sequence corresponding to the target content.

At 430, the server may generate the target emoji sequence including multiple emojis based on the emoji generation instruction.

In detail, the 430 of generating the target emoji sequence may include the following.

At 4310, the server may obtain a first number corresponding to the target content based on the emoji generation instruction.

At 4320, the server may convert the first number into an M-ary number to obtain a second number, where M is a positive integer greater than 1.

At 4330, the server may convert digits of the second number into corresponding ones of M preset emojis based on a one-to-one correspondence between the M preset emojis and M-ary digits from 0 to (M−1), to obtain the target emoji sequence.

The implementations of 430 of generating the target emoji sequence including the multiple emojis may refer to the descriptions of 270.

At 440, the server may send the target emoji sequence to the first terminal device.

In some implementations, after receiving the emoji generation instruction sent by the first terminal device, the server may be configured to generate the sharing token after generating the target emoji sequence and send the sharing token to the first terminal device. In this way, the first terminal device can directly display the sharing token sent by the server to the user without generating the sharing token itself.

Based on the above, in the disclosure, the emoji generation instruction may be configured to instruct the generation of the sharing token corresponding to the target content. In addition, as illustrated in FIG. 14, after the 430 of generating by the server the target emoji sequence including multiple emojis based on the emoji generation instruction, the method further includes the following.

At 450, the server may generate the sharing token containing the target emoji sequence.

For the specific descriptions of the sharing token, reference may be made to the corresponding description above, which are not be repeated here.

The 440 of sending the target emoji sequence to the first terminal device may include the following.

At 440a, the server may send the sharing token containing the target emoji sequence to the terminal device.

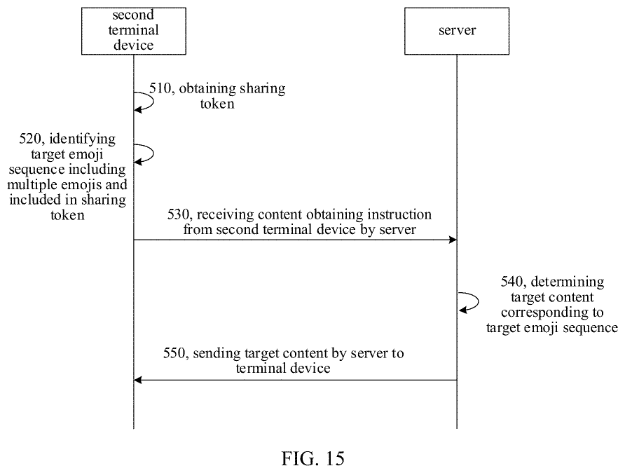

In some implementations, the software and hardware resources of the server can also be used to implement parsing the sharing token and determining the target content in the method according to embodiments of the disclosure. As illustrated in FIG. 15, embodiments the disclosure may further include the following.

At 510, the second terminal device may obtain a sharing token.

At 520, the second terminal device may identify a target emoji sequence included in the sharing token. The target emoji sequence includes multiple emojis.

In detail, the implementation process of 510 and 520 can refer to the corresponding descriptions of 230 and 240.

At 530, the second terminal device may send a content obtaining instruction to the server. The server may be configured to receive the content obtaining instruction sent by the second terminal device.

The content obtaining instruction includes the target emoji sequence including multiple emojis.

At 540, the server may determine the target content corresponding to the target emoji sequence based on the target emoji sequence.

In detail, the 540 of determining the target content may include the following.

At 5410, the server may convert each of the multiple emojis in the target emoji sequence to a corresponding digit, based on a one-to-one correspondence between the M preset emojis and M-ary digits from 0 to (M−1), and combine digits converted from the multiple emojis to obtain a second number that is an M-ary number, where M is a positive integer greater than 1.

At 5420, the server may convert the second number into the first number that is an N-ary number, where N is an integer greater than 1 and N is different from M.

At 5430, the server may determine the target content corresponding to the first number based on the first number.

The process of the 540 of generating the target emoji sequence including multiple emojis may refer to descriptions of the 250.

At 550, the server may send the target content to the terminal device.

In some implementations, the second terminal device may send the received sharing token to the server without parsing the sharing token, such that the server may be configured to identify the target emoji sequence included in the sharing token.

In some embodiments, the above method may reduce the resource overhead of the second terminal device.

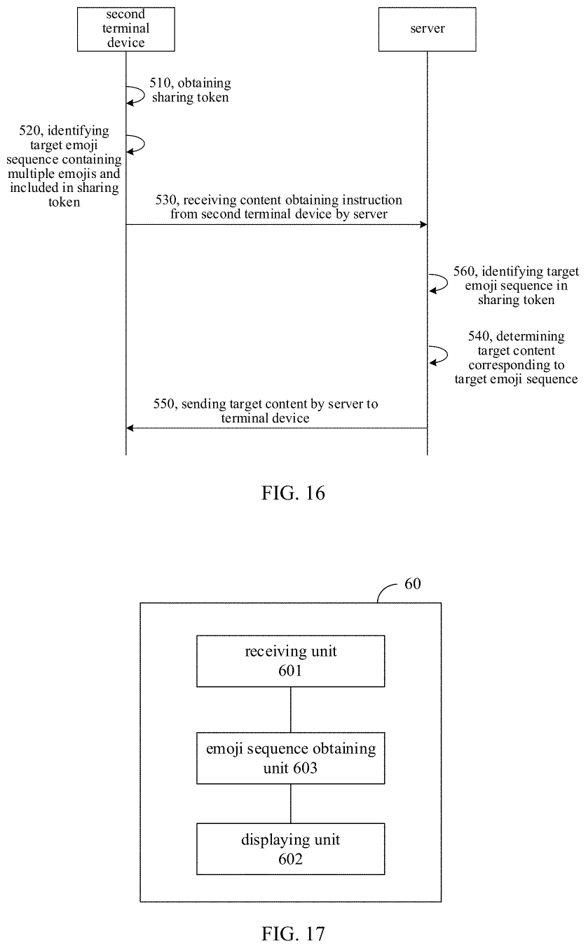

Based on the above concept, in embodiments of the disclosure, the content obtaining instruction sent by the second terminal device to the server may include the sharing token. As illustrated in FIG. 16, before the 540 of determining by the server the target content corresponding to the target emoji sequence based on the target emoji sequence, the method may further include the following.

At 560, the server may identify the target emoji sequence included in the sharing token.

The block 560 may include 5610-5620a, 5610-5620b or 5610-5620c.

At 5610, the server may identify a target emoji included in the sharing token.

In detail, the server may be configured to identify a first target emoji, a second target emoji, or both the first target emoji and the second target emoji included in the sharing token. The first target emoji may be configured to indicate a starting position of the target emoji sequence in the sharing token and/or, the second target emoji may be configured to indicate an ending position of the target emoji sequence in the sharing token.

In some implementations, based on the sharing token including the first target emoji, the method further includes the following.

At 5620a, the server may read a preset number of emojis before the first target emoji in the sharing token to obtain the target emoji sequence.

In some implementations, based on the sharing token including the second target emoji, the method further includes the following.

At 5620b, the server may read a preset number of emojis after the second target emoji in the sharing token to obtain the target emoji sequence.

In some implementations, based on the sharing token including both the first target emoji and the second target emoji, the method further includes the following.

At 5620c, the server may read multiple emojis between the first target emoji and the second target emoji in the sharing token to obtain the target emoji sequence.

Detailed implementations of the 560 and the sub-blocks 5620a, 5620b, and 5620c included in the 560 may refer to the corresponding descriptions of the block 240.

In embodiments of the disclosure, the target content can be determined based on the target emoji sequence in the sharing token. Therefore, there is no need to including the token code consisted of numbers and letters in the sharing token.

In some embodiments, the above-mentioned method may avoid the problem that the user experience is poor since the sharing token contains too many unreadable symbols by the user.

In some embodiments, emojis are commonly used by users in socially chatting. The shaking token generated according to embodiments of the disclosure is difficult to be identified.

In some embodiments, the above-mentioned method may improve the security of the sharing token during the transmission.

Based on the same concept as the above content sharing method, the disclosure also provides a terminal device. As illustrated in FIG. 17, the terminal device 60 may include a receiving unit 601 and a displaying unit 602.

The receiving unit 601 may be configured to receive a sharing operation for sharing target content.

The displaying unit 602 may be configured to display a sharing token in response to the sharing operation. The sharing token includes a target emoji sequence. The target emoji sequence includes a plurality of emojis. The target emoji sequence corresponds to the target content.

In some embodiments, as illustrated in FIG. 17, the terminal device 60 further includes an emoji sequence obtaining unit 603.

The emoji sequence obtaining unit 603 may be configured to obtain a first number corresponding to the target content in response to the sharing operation before the displaying unit displays the sharing token containing the target emoji sequence in response to the sharing operation.

The emoji sequence obtaining unit 603 may be further configured to convert the first number into a second number. The second number is an M-ary number, and M is a positive integer greater than 1.

The emoji sequence obtaining unit 603 may be further configured to obtain the target emoji sequence by converting digits of the second number into respective emojis of M preset emojis based on a one-to-one correspondence between the M preset emojis and M-ary digits from 0 to (M−1).

In some embodiments, the emoji sequence obtaining unit 603 may be configured to generate the first number with an identity document ID generator and store a correspondence between the first number and the target content in response to the sharing operation.

In some embodiments, storing the correspondence between the first number and the target content includes storing the correspondence between the first number and the target content into a database. In the database, an access address of the target content is stored as storage content and the first number is used as a storage ID for storing the storage content.

In some embodiments, the first number is an integer of long type.

In some embodiments, the sharing token further includes a first target emoji before the target emoji sequence, and/or a second target emoji after the target emoji sequence. The first target emoji may be configured to indicate a starting position of the target emoji sequence in the sharing token, and/or the second target emoji may be configured to indicate an ending position of the target emoji sequence in the sharing token.

In some embodiments, the target emoji sequence included in the sharing token includes a non-emoji symbol between two adjacent emojis. The non-emoji symbol includes one or more of a word, a letter and a number.

Implementations and technical effects of the terminal device 60 and each functional unit included in the terminal device 60 can refer to the corresponding implementations of the first terminal device according to embodiments of the disclosure, which are not be repeated here.

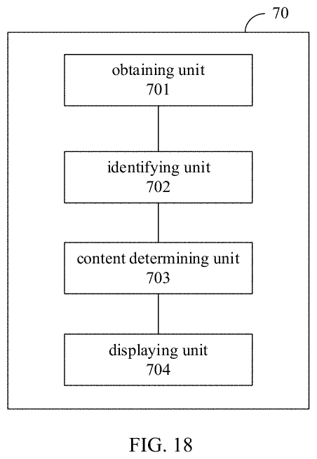

In addition, embodiments of the disclosure further provide a terminal device. As illustrated in FIG. 18, the terminal device 70 includes an obtaining unit 701, an identifying unit 702, a content determining unit 703 and a displaying unit 704.

The obtaining unit 701 may be configured to obtain a sharing token.

The identifying unit 702 may be configured to obtain a target emoji sequence by identifying the sharing token. The target emoji sequence includes multiple emojis.

The content determining unit 703 may be configured to obtain target content corresponding to the target emoji sequence.

The displaying unit 704 may be configured to display the target content.

In some embodiments, the content determining unit 703 may be configured to: obtain a second number by combining digits converted from the multiple emojis in the target emoji sequence based on a one-to-one correspondence between M emojis and M-ary digits from 0 to (M−1). The second number is an M-ary number, where M is a positive integer greater than 1.

The content determining unit 703 may be further configured to convert the second number into a first number. The first number is an N-ary number, where N is a positive integer greater than 1 and N is different from M.

The content determining unit 703 may be further configured to determine the target content corresponding to the first number.

In some embodiments, determining the target content corresponding to the first number includes searching for a storage content from a database by using the first number as a storage ID, and obtaining an access address of the target content by reading the storage content.

In some embodiments, the first number is an integer of long type.

In some embodiments, the identifying unit 702 may be configured to identify a first target emoji, and/or a second target emoji from the sharing token. The first target emoji may be configured to indicate a starting position of the target emoji sequence in the sharing token, and/or the second target emoji may be configured to indicate an ending position of the target emoji sequence in the sharing token. In addition, the identifying unit 702 may be further configured to obtain the target emoji sequence by reading a number of emojis before the second target emoji in the sharing token; obtain the targe emoji sequence by reading a number of emojis after the first target emoji in the sharing token; or obtaining the target emoji sequence by reading a number of emojis before the first target emoji and the second target emoji in the sharing token.

Implementations and technical effects of the terminal device 70 and each functional unit in the terminal device 70 can refer to the corresponding implementations of the second terminal device according to embodiments of the disclosure, which are not be repeated here.

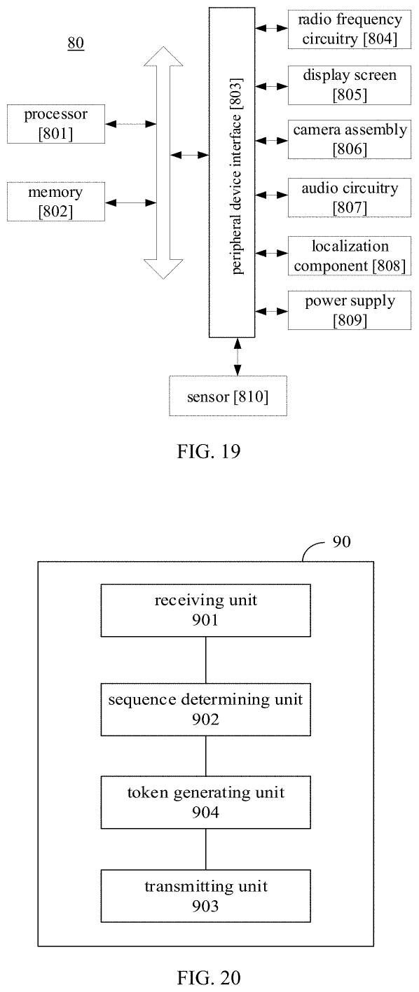

In addition, embodiments of the disclosure provide a terminal device. FIG. 19 is a schematic diagram illustrating a terminal device. As illustrated in FIG. 19, the terminal device 80 includes a processor 801 and a memory 802.

It can be understood that the terminal device 80 illustrated in FIG. 19 can implement all the functions of the first terminal device or the second terminal device in the foregoing embodiments. For example, the functions of each unit of the terminal device 60 or the terminal device 70 may be implemented in the processor 801 of the terminal device 80 by processing corresponding data.

The processor 801 may include one or more processing cores, such as a 4-core processor, an 8-core processor, and so on. The processor 110 may include an application processor (AP), a modem processor, a graphics processing unit (GPU), an image signal processor (ISP), a controller, a memory, and a video codec, a digital signal processor (DSP), a baseband processor, and/or neural-network processing unit (NPU). Different processing units may be independent devices or integrated in one or more processors.

The memory 802 may include one or more computer-readable storage media, which may be non-transitory. The memory 802 may also include a high-speed random-access memory and a non-volatile memory, such as one or more magnetic disk storage devices and flash memory storage devices. In some embodiments, the non-transitory computer-readable storage medium in the memory 802 may be configured to store at least one instruction. The at least one instruction is executed by the processor 801 to implement a method for sharing content according to embodiments of the disclosure.

In some embodiments, the terminal device 80 may further include: a peripheral device interface 803 and at least one peripheral device. The processor 801, the memory 802, and the peripheral device interface 803 may be connected by a bus or a signal line. Each peripheral device can be connected to the peripheral device interface 803 through a bus, a signal line or a circuit board. In detail, the peripheral device includes at least one of: a radio frequency circuitry 804, a display screen 805, a camera component 806, an audio circuit 807, a localization component 808, and a power supply 809.

The peripheral device interface 803 may be configured to connect at least one peripheral device related to I/O (input/output) to the processor 801 and the memory 802. In some embodiments, the processor 801, the memory 802, and the peripheral device interface 803 are integrated on the same chip or circuit board. In some other embodiments, one of two of the processor 801, the memory 802 and the peripheral device interface 803 can be implemented on a separate chip or circuit board, which is not limited in this embodiment.

The radio frequency circuitry 804 may be configured to receive and transmit RF (radio frequency) signals (also called as electromagnetic signals). The radio frequency circuitry 804 may be configured to communicate with a communication network and other communication devices through electromagnetic signals. The radio frequency circuitry 804 may be configured to convert electrical signals into electromagnetic signals for transmission, or convert received electromagnetic signals into electrical signals. In some embodiments, the radio frequency circuitry 404 includes an antenna system, an RF transceiver, one or more amplifiers, a tuner, an oscillator, a digital signal processor, a codec chipset, a user identity module card, and the like. The radio frequency circuitry 804 can communicate with other video synthesis devices through at least one wireless communication protocol. The wireless communication protocol includes, but is not limited to, a metropolitan area network, various generations of mobile communication networks, such as 2G (2 Generation), 3G (3 Generation), 4G (4 Generation), and 5G (5 Generation), a wireless local area network and/or a Wi-Fi (wireless fidelity) network. In some embodiments, the radio frequency circuitry 804 may further include a circuitry related to NFC (near field communication), which is not limited in the disclosure.

The display screen 805 may be configured to display a UI (user interface). The UI can include graphics, text, icons, videos, and any combination thereof. When the display screen 805 is a touch display screen, the display screen 805 also has an ability to collect touch signals on or above the surface of the display screen 805. The touch signal can be input to the processor 801 as a control signal for processing. In this case, the display screen 805 may also be configured to provide virtual buttons and/or virtual keyboards, also called soft buttons and/or soft keyboards. In some embodiments, the number of the display screen 805 may be one. The display screen 805 is provided on the front panel of the terminal device 80. The display screen 805 may be made of LCD (liquid crystal display) or OLED (organic light emitting diode).

The camera assembly 806 may be configured to capture images or record videos. In some embodiments, the camera assembly 806 includes a front camera and a rear camera. Generally, the front camera is arranged on the front panel of the video synthesis device, and the rear camera is arranged on the back of the video synthesis device. The audio circuitry 807 may include a microphone and a speaker. The microphone may be configured to collect sound waves of the user and the environment, and convert the sound waves into electrical signals to be input to the processor 801 for processing, or input to the radio frequency circuitry 404 to implement voice communication. For the purpose of stereo collection or noise reduction, there may be multiple microphones, which are respectively set in different parts of the terminal device 80. The microphone can also be an array microphone or an omnidirectional collection microphone. The speaker is used to convert the electrical signal from the processor 801 or the radio frequency circuitry 804 into sound waves. The speaker can be a traditional thin-film speaker or a piezoelectric ceramic speaker. When the speaker is a piezoelectric ceramic speaker, not only can the electrical signal be converted into human audible sound waves, but also the electrical signal can be converted into human inaudible sound waves for purposes such as distance measurement. In some embodiments, the audio circuitry 807 may also include a headphone jack.

The localization component 808 may be configured to locate a current geographic location of the terminal device 80 to implement navigation or LBS (location-based service). The localization component 808 may be a localization component based on the GPS (global positioning system) of the United States, the Beidou system of China, the Granus system of Russia, or the Galileo system of the European Union.

The power supply 809 may be configured to supply power to various components of the terminal device 80. The power source 809 may be a battery of alternating current, a battery of direct current, a disposable battery, or a rechargeable battery. When the power source 809 includes a rechargeable battery, the rechargeable battery may support wired charging or wireless charging. The rechargeable battery can also be configured to support fast charging technology.

In some embodiments, the terminal device 80 further includes one or more sensors 810. The one or more sensors 810 include, but are not limited to: an acceleration sensor, a gyroscope sensor, a pressure sensor, a fingerprint sensor, an optical sensor, and a proximity sensor.

The acceleration sensor can be configured to detect the magnitude of acceleration on the three coordinate axes of the coordinate system established by the terminal device 80. The gyroscope sensor can detect the body direction and rotation angle of the terminal device 80, and the gyroscope sensor can cooperate with the acceleration sensor to collect the user's 3D actions on the terminal device 80. The pressure sensor may be arranged on the side frame of the terminal device 80 and/or the lower layer of the touch screen 805. When the pressure sensor is arranged on the side frame of the terminal device 80, the user's holding signal of the terminal device 80 can be detected. The fingerprint sensor may be configured to collect the user's fingerprint. The optical sensor may be configured to collect the ambient light intensity. The proximity sensor, also called the distance sensor, is usually arranged on the front panel of the terminal device 80. The proximity sensor may be configured to collect the distance between the user and the front of the terminal device 80.

Further, embodiments of the disclosure provide a server. FIG. 20 is a schematic diagram of a server 90 according to embodiments of the disclosure. The server 90 may include a receiving unit 901, a sequence generating unit 902 and a transmitting unit 903.

The receiving unit 901 may be configured to receive an emoji generating instruction from a terminal device. The emoji generating instruction carries identification information of target content. The emoji generating instruction may be configured to generate a target emoji sequence corresponding to the target content.

The sequence generating unit 902 may be configured to generate a target emoji sequence based on the emoji generating instruction. The target emoji sequence includes multiple emojis and corresponds to the target content.

The transmitting unit 903 may be configured to transmit the target emoji sequence to the terminal device.

In some embodiments, the sequence generating unit 902 may be configured to obtain a first number corresponding to the target content based on the emoji generating instruction.

The sequence generating unit 902 may be further configured to convert the first number into a second number. The second number is an M-ary number, where M is a positive integer greater than 1.

The sequence generating unit 902 may be further configured to obtain the target emoji sequence by converting digits of the second number into respective emojis based on a one-to-one correspondence between M emojis and M-ary digits from 0 to (M−1).

In some embodiments, obtaining the first number corresponding to the target content includes generating the first number with an identity document ID generator and store a correspondence between the first number and the target content based on the emoji generating instruction.

In some embodiments, storing the correspondence between the first number and the target content includes storing the correspondence between the first number and the target content into a database. In the database, an access address of the target content is stored as storage content and the first number is used as a storage ID for storing the storage content.

In some embodiments, the first number is an integer of long type.

In some embodiments, the emoji generating instruction may be configured to instruct to generate a sharing token corresponding to the target content. The server 90 further includes a token generating unit 904.

The token generating unit 904 may be configured to generate the sharing token including the target emoji sequence.

The transmitting unit 903 may be configured to transmit the sharing token to the terminal device.

In some embodiments, the sharing token further includes a first target emoji before the target emoji sequence, and/or a second target emoji after the target emoji sequence. The first target emoji may be configured to indicate a starting position of the target emoji sequence in the sharing token, and/or the second target emoji may be configured to indicate an ending position of the target emoji sequence in the sharing token.

In some embodiments, the target emoji sequence included in the sharing token includes a non-emoji symbol between two adjacent emojis. The non-emoji symbol includes one or more of a word, a letter and a number.

Implementations and technical effects of the server 90 and each functional unit of the server 90 can refer to the corresponding implementations of the method for sharing content according to embodiments of the disclosure, which are not be repeated here.

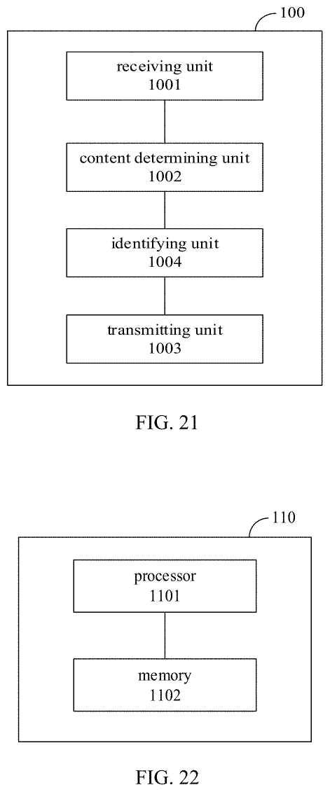

In addition, embodiments of the disclosure provide a server. As illustrated in FIG. 21, the server includes a receiving unit 1001, a content determining unit 1002 and a transmitting unit 1003.

The receiving unit 901 may be configured to receive a content obtaining instruction from a terminal device. The content obtaining instruction includes a target emoji sequence and the target emoji sequence includes multiple emojis.

The content determining unit 1002 may be configured to determine target content corresponding to the target emoji sequence.

The transmitting unit 1003 may be configured to transmit the target content to the terminal device.

In some embodiments, the content determining unit 1002 may be configured to obtain a second number by combining digits converted from the plurality of emojis in the target emoji sequence based on a one-to-one correspondence between M emojis and M-ary digits from 0 to (M−1). The second number is an M-ary number, where M is a positive integer greater than 1.

The content determining unit 1002 may be further configured to convert the second number into a first number. The first number is an N-ary number, where N is a positive integer greater than 1 and N is different from M.

The content determining unit 1002 may be further configured to determine the target content corresponding to the first number.

In some embodiments, determining the target content corresponding to the first number includes searching for a storage content from a database by using the first number as a storage ID and obtaining an access address of the target content by reading the storage content.

In some embodiments, the first number is an integer of long type.

In some embodiments, the content obtaining instruction comprises a sharing token. The server further includes an identifying unit 1004.

The identifying unit 1004 may be configured to identify the target emoji sequence included in the sharing token based on the target emoji sequence before determining the target content corresponding to the target emoji sequence.

In some embodiments, the identifying unit 1004 may be configured to identify a first target emoji and/or a second target emoji from the sharing token. The first target emoji may be configured to indicate a starting position of the target emoji sequence in the sharing token, and/or the second target emoji may be configured to indicate an ending position of the target emoji sequence in the sharing token.

The identifying unit 1004 may be further configured to obtain the target emoji sequence by reading a number of emojis before the second target emoji in the sharing token, obtain the target emoji sequence by reading a number of emojis after the first target emoji in the sharing token, or obtain the target emoji sequence by reading a number of emojis between the first target emoji and the second target emoji in the sharing token.

Implementations and technical effects of the server 100 and each functional unit of the server 100 can refer to the corresponding implementations of the method for sharing content according to embodiments of the disclosure, which are not be repeated here.

In addition, FIG. 22 is a schematic diagram illustrating another server according to embodiments of the disclosure. The server 110 may have relatively large differences due to different configurations or performances, and may include one or more processors (central processing units, CPU) 1101 and one or more memories 1102. The memory 1102 has at least one instruction stored thereon. The at least one instruction is loaded and executed by the processor 1101 to realize the function of the server in the method for sharing content according to embodiments of the disclosure. For example, the server 110 may be configured to implement the functions of the server 90 or 100 described above.

Certainly, the server 110 may also have components such as a wired or wireless network interface, a keyboard, and an input/output interface for input and output. The server 1100 may also include other components for implementing device functions, which are not be repeated here.

Embodiments of the disclosure also provides a computer-readable storage medium having instructions stored thereon. When the instructions are executed by the processor of the computer, the computer may be configured to execute a part or all of functions of the terminal device or the server according to embodiments of the disclosure, to implement the method for sharing content according to embodiments of the disclosure.

Embodiments of the present disclosure further provide a computer program product having instructions. When the instructions are running on a computer, the computer may be configured to execute all or part of the functions of the terminal device or server according to embodiments of the disclosure, to implement the method for sharing content according to embodiments of the disclosure.

Other embodiments of the disclosure will be apparent to those skilled in the art after considering the description and practicing the disclosure disclosed herein. The disclosure is intended to cover any variations, uses or adaptive changes of the disclosure. These variations, uses or adaptive changes are in accordance with general principles of the disclosure and include common knowledge or technical means in the art that are not disclosed herein. The description and embodiments are to be regarded as illustrative only, and the real scope and spirit of the disclosure are pointed out in the attached claims.

It should be understood that the disclosure is not limited to the precise structures described above and illustrated in the drawings, and various modifications and changes may be made without departing from the scope thereof. The scope of the present disclosure is merely limited by the attached claims.

What is claimed is:

1. A method for sharing content, being applicable to an electronic device, the method comprising:
obtaining a target emoji sequence based on an instruction related to target content, wherein the target emoji sequence corresponds to the target content;
obtaining a sharing token based on the target emoji sequence; and
sharing the target content based on the sharing token.

2. The method of claim 1, wherein the instruction comprises a sharing operation in response to the electronic device being a terminal device; and the instruction comprises an emoji generation instruction in response to the electronic device being a server and the emoji generation instruction is from a terminal device.

3. The method of claim 1, wherein the method further comprises:
obtaining a first number corresponding to the target content in response to the instruction;
converting the first number into a second number, wherein the second number is an M-ary number, where M is an integer greater than 1; and
obtaining the target emoji sequence by converting the second number into emojis based on a correspondence between M emojis and M-ary digits from 0 to (M−1).

4. The method of claim 3, wherein said obtaining the first number comprises:
obtaining the first number with an identity document generator;
storing a correspondence between the first number and the target content.

5. The method of claim 4, further comprising:
storing the correspondence between the first number and the target content in a database, wherein the database stores access address of the target content as storing content and the first number as storing identity document of the storing content.

6. The method of claim 3, wherein the first number is an integer of long type.

7. The method of claim 1, wherein the sharing token further comprises a first target emoji before the target emoji sequence, and a second target emoji after the target emoji sequence;
wherein the first target emoji is configured to indicate a starting of the target emoji sequence, and the second target emoji is configured to indicate an ending of the target emoji sequence.

8. The method of claim 1, wherein the target emoji sequence comprised in the sharing token comprises at least one of a word, a letter or a number between two adjacent emojis.

9. The method of claim 3, wherein the second number is a 32-ary number.

10. A method for sharing content, being applicable to an electronic device, the method comprising:
obtaining an instruction comprising a target emoji sequence; and
obtaining target content corresponding to the target emoji sequence.

11. The method of claim 10, wherein the instruction is a sharing token in response to the electronic device being a terminal device; and the instruction is a content obtaining instruction in response to the electronic device being a server and the content obtaining instruction is from a terminal device.

12. The method of claim 10, wherein said obtaining the target content comprises:
obtaining a second number by combining digits converted from the plurality of emojis in the target emoji sequence based on a correspondence between M emojis and M-ary digits from 0 to (M−1), wherein the second number is an M-ary number, where M is an integer greater than 1;
converting the second number into a first number, wherein the first number is an N-ary number, where N is an integer greater than 1 and N is different from M; and
obtaining the target content corresponding to the first number.

13. The method of claim 12, wherein said obtaining the target content corresponding to the first number comprises:
searching for storing content from a database by using the first number as a storing identity document of the storing content, and obtaining an access address of the target content by reading the storing content.

14. The method of claim 12, wherein the first number is an integer of long type.

15. The method of claim 10, wherein said obtaining the target emoji sequence comprises:
identifying a first target emoji, and a second target emoji from a sharing token comprised in the instruction, wherein the first target emoji is configured to indicate a starting of the target emoji sequence, and the second target emoji is configured to indicate an ending of the target emoji sequence; and
obtaining the target emoji sequence based on a number of emojis before the second target emoji, after the first target emoji, or between the first target emoji and the second target emoji in the sharing token.

16. An electronic device, comprising a processor, and a memory configured to store instructions executable by the processor;
wherein the processor is configured to execute the instructions to implement operations of:
obtaining a target emoji sequence based on an instruction related to target content, wherein the target emoji sequence corresponds to the target content;
obtaining a sharing token based on the target emoji sequence; and
sharing the target content based on the sharing token.

17. The electronic device of claim 16, being a terminal device or a server; and
wherein the instruction comprises a sharing operation in response to the electronic device being a terminal device; and the instruction comprises an emoji generation instruction in response to the electronic device being a server.

18. The electronic device of claim 16, wherein the operations further comprise:
obtaining a first number corresponding to the target content, in response to the instruction;
converting the first number into a second number, wherein the second number is an M-ary number, where M is an integer greater than 1; and
obtaining the target emoji sequence by converting the second number into emojis based on a correspondence between M emojis and M-ary digits from 0 to (M−1).

19. The electronic device of claim 18, wherein the operations further comprise:
obtaining the first number with an identity document generator; and
storing a correspondence between the first number and the target content.

20. The electronic device of claim 19, wherein the operations further comprise:
storing the correspondence between the first number and the target content in a database, wherein the database stores access address of the target content as storing content and the first number as storing ID of the storing content.
